(19) United States
(12) Patent Application Publication
(10) Pub. No.: US 2017/0260365 A1
(43) Pub. Date: Sep. 14, 2017

(54) RESIN COMPOSITION AND USES OF THE SAME

(71) Applicant: TAIWAN UNION TECHNOLOGY CORPORATION, Chupei City (TW)

(72) Inventors: Shur-Fen Liu, Chupei City (TW); Meng-Huei Chen, Chupei City (TW)

(21) Appl. No.: 15/174,107

(22) Filed: Jun. 6, 2016

(30) Foreign Application Priority Data
Mar. 10, 2016 (TW) 105107328

(51) Int. Cl. C08K 5/5313; C08L 71/12; B32B 15/08; C08J 5/24; C08K 3/36; C08K 5/3492; C08L 35/00

(52) U.S. Cl. CPC C08K 5/5313; C08K 5/34924; C08L 71/123; C08L 35/00; C08J 5/24; C08K 3/36; B32B 15/08; C08L 2201/02; C08L 2205/025; C08L 2205/03; C08L 2205/035; C08J 2371/12; C08J 2335/00; C08J 2435/00; C08J 2400/26; C08J 2463/00; C08L 2203/206; B32B 2305/076

(57) ABSTRACT

A resin composition, comprising the following components:
(a) a thermal-curable resin system, which has a dielectric loss (DO of not higher than 0.006 at 10 GHz; and
(b) a metal hypophosphite of formula (I),

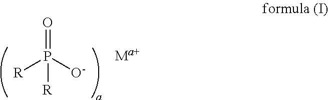

wherein a, R, and M^{a+} are as defined in the specification, and wherein the amount of the metal hypophosphite (b) is 1 wt % to 30 wt % based on the total weight of the resin system (a) and the metal hypophosphite (b).

### CLAIM FOR PRIORITY

This application claims the benefit of Taiwan Patent Application No. 105107328 filed on Mar. 10, 2016, the subject matters of which are incorporated herein by reference.

### BACKGROUND OF THE INVENTION

Field of the Invention

The present invention relates to a resin composition, especially a resin composition comprising a metal hypophosphite. The present invention also relates to a prepreg and laminate provided by using the resin composition.

Descriptions of the Related Art

Printed circuit boards (PCBs) are circuit substrates that are used for electronic devices to load other electronic components and to electrically connect the components to provide a stable circuit working environment. One kind of conventional printed circuit boards is a copper clad laminate (CCL), which is primarily composed of resin(s), reinforcing material(s) and copper foil(s). Examples of resins include epoxy resins, phenolic resins, polyamine formaldehyde resins, silicone resins, and Teflon; and examples of reinforcing materials include glass fiber cloths, glass fiber mats, insulating papers, and linen cloths.

In general, a printed circuit board can be prepared by using the following method: immersing a reinforcing material such as a glass fiber fabric into a resin (such as epoxy resin), and curing the immersed glass fiber fabric into a half-cured state, i.e., B-stage, to obtain a prepreg; superimposing certain layers of the prepregs and superimposing a metal foil on at least one external surface of the superimposed prepregs to provide a superimposed object; hot-pressing the superimposed object, i.e., C-stage, to obtain a metal clad laminate; etching the metal foil on the surface of the metal clad laminate to form a defined circuit pattern; and finally, drilling a plurality of holes on the metal clad laminate and plating these holes with a conductive material to form via holes to accomplish the preparation of the printed circuit board.

In many applications, resin materials require good flame retardance. In some cases, a resin with a flame resistance property such as a halogenated polymer is sufficient to provide the desired flame retardance. If the flame retardance of a resin is insufficient to provide the desired flame retardance, it would be necessary to add a flame retardant into the resin. Known compounds capable of being used as flame retardants include inorganic hydroxides, organic phosphorous compounds, organic halogen compounds, halogen-containing organic phosphorous compounds, etc. However, during the curing process of a resin containing a halogen-containing compound, the halogen-containing compound will generate hydrogen halides through thermal decomposition, and the generated hydrogen halides will corrode molds and adversely affect the properties of the resin and cause discoloration of the resin. Similarly, during the recycling process (e.g., an incineration processing) of the product of the cured resin, the halogen-containing compounds will generate biological hazard gases such as hydrogen halides. Hence, halogen-containing compounds do not meet current environmental protection requirements, and halogen-free flame retardants are much in demand.

Phosphorous-containing compounds are one of the most popular halogen-free flame retardants. Examples of phosphorous-containing compounds include triphenyl phosphate (TPP), tricresyl phosphate (TCP), and the like. However, such phosphorous-containing compounds are generally in the form of a liquid or a solid with a low melting point under room temperature and are volatile substances. Hence, such phosphorous-containing compounds tend to lower the curing temperature of the resins which they applied into and cause caking and leakage during fluxing.

Applications of phosphorous-containing compounds as flame retardants have been disclosed in U.S. Pat. No. 3,900,444, U.S. Pat. No. 4,036,811, and U.S. Pat. No. 6,207,736. These patents use alkali salts of substituted phosphoric acids or hypophosphites as flame retardants for thermoplastic polymers (e.g., polyesters). However, if such phosphorous-containing compounds are applied into resin compositions for preparing printed circuit boards, they tend to adversely affect electrical properties, such as the dielectric constant (Dk) and dielectric loss (DO of the laminates thus prepared, and physicochemical properties, such as thermal resistance, moisture resistance and electrical erosion resistance of the laminates thus prepared. Applications of phosphorous-containing compounds as flame retardants can also be found in U.S. Pat. No. 7,208,539, which discloses a thermosetting resin composition comprising the metal salt of a di-substituted phosphinic acid and a resin with a dielectric constant of 2.9 or less at a frequency of 1 GHz or more.

### SUMMARY OF THE INVENTION

An objective of the present invention is to provide a resin composition, comprising:

(a) a thermal-curable resin system, which has a dielectric loss (DO of not higher than 0.006 at 10 GHz; and
(b) a metal hypophosphite of formula (I),

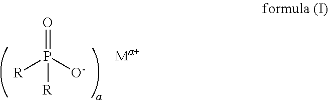

wherein a is an integer from 1 to 4, R is H or absent, and M^{a+} is an ion of a metal selected from a group consisting of lithium, sodium, potassium, magnesium, calcium, strontium, barium, aluminum, germanium, tin, antimony, zinc, titanium, zirconium, manganese, iron, copper, and cerium, and
wherein the amount of the metal hypophosphite (b) is 1 wt % to 30 wt % based on the total weight of the resin system (a) and the metal hypophosphite (b).

Another objective of the present invention is to provide a prepreg, which is prepared by immersing a substrate into the resin composition described above, and drying the immersed substrate.

Yet another objective of the present invention is to provide a laminate, comprising a synthetic layer and a metal layer, wherein the synthetic layer is made from the prepreg described above.

To render the above objectives, technical features and advantages of the present invention more apparent, the present invention will be described in detail with reference to some embodiments hereinafter.

### BRIEF DESCRIPTION OF THE DRAWINGS

Not applicable.

### DESCRIPTION OF THE PREFERRED EMBODIMENT

Hereinafter, some embodiments of the present invention will be described in detail. However, without departing from the spirit of the present invention, the present invention may be embodied in various embodiments and should not be limited to the embodiments described in the specification. Furthermore, for clarity, the size of each element and each area may be exaggerated in the appended drawings and not depicted in actual proportion. Unless it is additionally explained, the expressions “a,” “the,” or the like recited in the specification (especially in the claims) should include both the singular and plural forms. Furthermore, unless it is additionally explained, while describing the constituents in the solution, mixture and composition in the specification, the amount of each constituent is calculated based on the solid content, i.e., regardless of the weight of the solvent.

The present invention relates to a resin composition with excellent flame retardance. In the resin composition, a resin system with specific electrical properties and a metal hypophosphite with a specific structure are used in combination at a specific ratio so that laminates prepared thereby could be provided with satisfactory physicochemical properties and excellent flame retardance, heat resistance and peeling strength without adversely affecting their electrical properties.

Specifically, the resin composition of the present invention comprises (a) a thermal-curable resin system and (b) a metal hypophosphite, wherein the thermal-curable resin system (a) has a dielectric loss (DO of not higher than 0.006 at 10 GHz, and the metal hypophosphite (b) has the structure of formula (I).

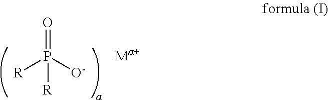

In formula (I), a is an integer from 1 to 4, R is H or absent, and M^{a+} is an ion of a metal selected from the group consisting of lithium, sodium, potassium, magnesium, calcium, strontium, barium, aluminum, germanium, tin, antimony, zinc, titanium, zirconium, manganese, iron, copper, and cerium. Preferably, a is an integer from 1 to 3, and M^{a+} is an ion of a metal selected from the group consisting of lithium, sodium, potassium, magnesium, calcium, strontium, barium, and aluminum. In some embodiments of the present invention, a is 3, and Ma⁺ is Al³⁺.

In the resin composition of the present invention, the amount of the metal hypophosphite (b) is 1 wt % to 30 wt %, preferably 10 wt % to 22 wt %, based on the total weight of the resin system (a) and the metal hypophosphite (b). If the amount of the metal hypophosphite (b) is higher than the designated range (e.g., higher than 30 wt %), the properties of laminates prepared therefrom, especially peeling strength thereof, will be adversely affected. In addition, if the amount of the metal hypophosphite (b) is lower than the designated range (e.g., lower than 1 wt %) or the resin composition does not comprise the metal hypophosphite (b), the laminates prepared therefrom will be deficient in the electrical properties, physicochemical properties and mechanical properties, and especially peeling strength and glass transition temperature (Tg).

It is known that the phrase “thermal-curable resins” refer to polymers that can be gradually cured by forming a network structure through heat treatment. In the resin composition of the present invention, the thermal-curable resin system can be provided by a single thermal-curable resin or provided by multiple thermal-curable resins through mixing. Regardless of using a single thermal-curable resin or a mixture of multiple thermal-curable resins, the dielectric loss (DO of the thermal-curable resin component thus obtained cannot be higher than 0.006 at 10 GHz.

Specifically, the thermal-curable resin system (a) of the resin composition according to the present invention may be provided by using thermal-curable resins selected from the group consisting of polyphenylene ether resins, bismaleimide resins, isocyanurates containing vinyl and/or allyl, elastomers containing butadiene and/or styrene, and epoxy resins. Alternatively, the thermal-curable resin system (a) may be provided by any combinations of the above thermal-curable resins. Yet alternatively, the thermal-curable resin system (a) may be provided by further combining at least one of the above thermal-curable resins with other known thermal-curable resins; however, in this case, it should be noted and maintained that the Df value of the thermal-curable resin system obtained therefrom cannot be higher than 0.006 at 10 GHz. In some embodiments of the present invention, the thermal-curable resin system (a) comprises at least two of the thermal-curable resins selected from the group consisting of polyphenylene ether resins, bismaleimide resins, isocyanurates containing vinyl and/or allyl, elastomers containing butadiene and/or styrene, and epoxy resins.

Polyphenylene ether resins may be any polyphenylene ether resins with reactive functional group(s), including, but not limited to, polyphenylene ether resins with acrylic acid group(s), polyphenylene ether resins with vinyl group(s), polyphenylene ether resins with carboxyl group(s), and the like. The “reactive functional group” in the context may be any group capable of conducting a curing reaction, such as hydroxyl groups, carboxyl groups, alkenyl groups, amino groups, and the like, but are not limited thereto. Examples of polyphenylene ether resins with reactive functional group(s) include, but are not limited to, polyphenylene ether resins with the structure of formula (II):

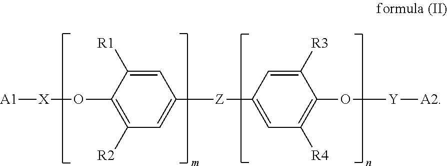

In formula (II),
X and Y are independently

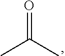

an alkenyl-containing group or absent, and it is preferred that X and Y are independently absent or

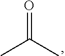

or X has the structure of formula (II-1) and Y has the structure of formula (II-2):

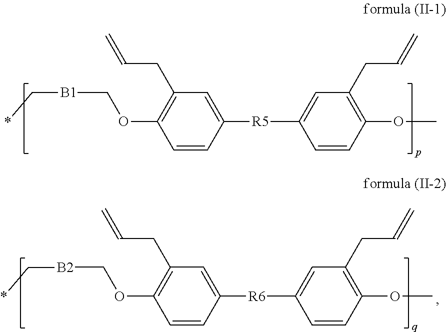

in formulas (II-1) and (II-2),
* indicates the end connecting oxygen (—O—) of formula (II);
B1 and B2 are independently

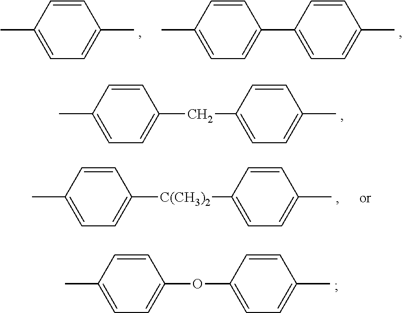

R5 and R6 are independently —O—, —SO₂—, or —C(CH₃)₂—, or absent; and
p and q are independently an integer, and 1≦p+q<20, preferably 1≦p+q<10, and more preferably 1≦p+q<3;
   R1, R2, R3 and R4 are independently H or substituted or unsubstituted C₁-C₅ alkyl, such as methyl, ethyl, n-propyl, isopropyl, n-butyl, etc.;
   m and n are independently an integer from 0 to 100, with the proviso that m and n are not 0 at the same time, and the range of m and n is preferably 1≦(m+n)≦100, and more preferably 5≦(m+n)≦30;
   A1 and A2 are independently

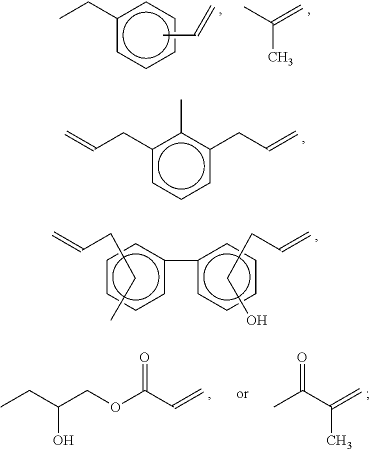

Z is absent, —O—,

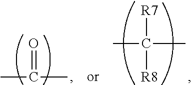

wherein R7 and R8 are independently H or C₁-C₁₂ alkyl.

Suitable bismaleimide resins may have the structure of formula (III).

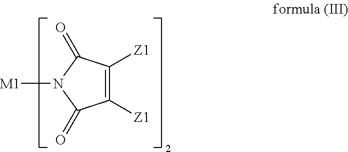

In formula (III), M1 is a C₂-C₄₀ divalent group and is aliphatic, alicyclic, aromatic, or heterocyclic. It is preferred that M1 is substituted or unsubstituted methylene (—CH₂—),

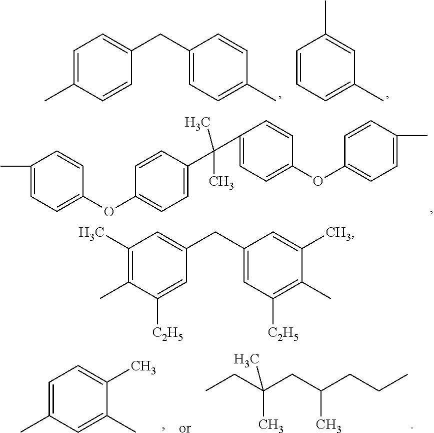

The Z1 groups are independently H, halogen, or C₁—O₅ alkyl. In some embodiments of the present invention, M1 is

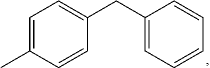

and both of the Z1 groups are H.

Specific examples of bismaleimide resins include, but are not limited to, 1,2-bismaleimidoethane, 1,6-bismaleimidohexane, 1,3-bismaleimidobenzene, 1,4-bismaleimidobenzene, 2,4-bismaleimidotoluene, 4,4′-bismaleimidodiphenylmethane, 4,4′-bismaleimidodiphenylether, 3,3′-bismaleimidodiphenylsulfone, 4,4′-bismaleimidodiphenylsulfone, 4,4′-bismaleimidodicyclohexylmethane, 3,5-bis(4-maleimidophenyOpyridine, 2,6-bismaleimidopyridine, 1,3-bis(maleimidomethyl)cyclohexane, 1,3-bis(maleimidomethyObenzene, 1,1-bis(4-maleimidophenyl)cyclohexane, 1,3-bis(dichloromaleimido)benzene, 4,4′-biscitraconimidodiphenylmethane, 2,2-bis(4-maleimidophenyl)propane, 1-phenyl-1,1-bis(4-maleimidophenyl)ethane, α,α-bis(4-maleimidophenyl)toluene, 3,5-bismaleimido-1,2,4-triazole, N,N′-ethylenebismaleimide, N,N′-hexamethylenebismaleimide, N,N′-m-phenylenebismaleimide, N,N′-p-phenylenebismaleimide, phenylmethanebismaleimide, N,N′-4,4′-diphenyletherbismaleimide, N,N′-4,4′-diphenylsufonebismaleimide, N,N′-4,4′-dicyclohexylmethanebismaleimide, N,N′-α,α′-4,4′-dimethylenecyclohexane bismaleimide, N,N′-m-xylenebismaleimide, N,N′-4,4′-diphenylcyclohexanebismaleimide, N,N′-methylenebis(3-chloro-p-phenylene)bismaleimide, and combinations thereof.

Suitable isocyanurates containing vinyl and/or allyl include, but are not limited to, triallyl isocyanurate (TAIC), triallyl cyanurate (TAC), and a combination thereof. In some embodiments of the present invention, triallyl isocyanurate (TAIC) is used.

Suitable elastomers containing butadiene and/or styrene include, but are not limited to, homopolymers of butadiene, styrene-butadiene copolymers (SBR), styrene-butadiene-styrene copolymers (SBS), acrylonitrile-butadiene copolymers, hydrogenated styrene-butadiene-styrene copolymers, styrene-isoprene-styrene copolymers (SIS), hydrogenated styrene-isoprene-styrene copolymers, hydrogenated styrene (butadiene/isoprene) styrene copolymers, polystyrene, and combinations thereof. In some embodiments of the present invention, homopolymers of butadiene, styrene-butadiene copolymers, styrene-butadiene-styrene copolymers, or combinations thereof are used.

Suitable epoxy resins may have the structure of formula (IV).

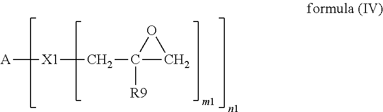

In formula (IV), A is an organic or inorganic group with a valence of n1, R9 is H or C₁-C₆ alkyl, X1 is oxygen or nitrogen, m1 is 1 or 2 and consistent with the valence of X1, and n1 is an integer from 1 to 100. Preferably, n1 is an integer from 2 to 8, and most preferably, n1 is an integer from 2 to 4.

Suitable epoxy resins may include products produced by the reaction of epichlorohydrin or epibromohydrin with a phenolic compound. Suitable phenolic compounds include, for example, resorcinol, catechol, hydroquinone, 2,6-dihydroxy naphthalene, 2,7-dihydroxynapthalene, 2-(diphenylphosphoryl)hydroquinone, bis(2,6-dimethylphenol), 2,2′-biphenol, 4,4-biphenol, 2,2′,6,6′-tetramethylbiphenol, 2,2′,3,3′,6,6′-hexamethylbiphenol, 3,3′,5,5′-tetrabromo-2,2′6,6′-tetramethylbiphenol, 3,3′-dibromo-2,2′,6,6′-tetramethylbiphenol, 2,2′,6,6′-tetramethyl-3,3′-dibromobiphenol, 4,4′-isopropylidenediphenol (bisphenol A), 4,4′-isopropylidenebis(2,6-dibromophenol) (tetrabromobisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′-(1,3-phenylenediisopropylidene)bisphenol (bisphenol M), 4,4′-isopropylidenebis(3-phenylphenol), 4,4′-(1,4-phenylenediisoproylidene)bisphenol (bisphenol P), 4,4′-ethylidenediphenol (bisphenol E), 4,4′-oxydiphenol, 4,4′-thiodiphenol, 4,4′-thiobis(2,6-dimethylphenol), 4,4′-sulfonyldiphenol, 4,4′-sulfonylbis(2,6-dimethylphenol), 4,4′-sulfinyldiphenol, 4,4′-(hexafluoroisoproylidene)bisphenol (Bisphenol AF), 4,4′-(1-phenylethylidene)bisphenol (Bisphenol AP), bis(4-hydroxyphenyl)-2,2-dichloroethylene (Bisphenol C), bis(4-hydroxyphenyl)methane (Bisphenol-F), bis(2,6-dimethyl-4-hydroxyphenyl)methane, 4,4′-(cyclopentylidene)diphenol, 4,4′-(cyclohexylidene)diphenol (Bisphenol Z), 4,4′-(cyclododecylidene)diphenol, 4,4′-(bicyclo[2.2.1]heptylidene)diphenol, 4,4′-(9H-fluorene-9,9-diyl)diphenol, 3,3-bis(4-hydroxyphenyl)isobenzofuran-1(3H)-one, 1-(4-hydroxyphenyl)-3,3-dimethyl-2,3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3,3′-tetrahydro-1,1′-spirobi[indene]-5-,6′-diol (Spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, bis(4-hydroxyphenyl)phenylphosphine oxide, dicyclopentadienylbis(2,6-dimethyl phenol), dicyclopentadienyl bis(2-methylphenol), dicyclopentadienyl bisphenol, and mixtures thereof. Specific synthesis methods regarding epoxy resins can be performed by persons with ordinary skill in the art based on their ordinary skill after reading the disclosure of the subject application, and the synthesis methods are not the technical point of the present invention. Therefore, specific synthesis method of epoxy resins will not be described in detail herein.

In addition to the above illustrated resin types, the resin system (a) may optionally comprise other thermal-curable resins, such as phenolic resins, styrene maleic anhydride (SMA) resins or combinations thereof, with the proviso that the designated condition of dielectric loss (DO is not violated. The other thermal-curable resins may further have reactive functional group(s).

Curing agents and/or catalysts may be optionally added into the resin system (a) to improve curing effects. For example, in the case that the resin system (a) comprises epoxy resins, suitable curing agents include, but are not limited to, amine compounds, anhydrides, benzenediol compounds, bisphenol resin, polyhydric phenol resin, phenolic resins, and the like. Examples of amine compounds include aliphatic amine compounds, such as diethylene triamine (DETA), triethylene tetramine (TETA), tetraethylene pentamine (TEPA), diethylaminopropylamine (DEAPA), methylene diamine, N-aminoethylpyrazine (AEP), m-xylylene diamine (MXDA), and the like; aromatic amine compounds, such as m-phenylene diamine (MPDA), 4,4′-diaminodiphenylmethane (MDA), diaminodiphenylsulfone (DADPS), diaminodiphenyl ether, and the like; secondary or tertiary amine compounds, such as phenylmethyldimethylamine (BDMA), dimethylaminomethylphenol (DMP-10), tris(dimethylaminomethyl)phenol (DMP-30), piperidine, 4,4′-diaminodicyclohexylmethane, 1,4-diaminocyclohexane, 2,6-diaminopyridine, m-phenylenediamine, p-phenylenediamine, 4,4′-diaminodiphenylmethane, 2,2′-bis(4-aminophenyl)propane, benzidine, 4,4′-diaminophenyl oxide, 4,4′-diaminodiphenylsulfone, bis(4-aminophenyl)phenylphosphine oxide, bis(4-aminophenyl)methylamine, 1,5-diaminonaphthalene, m-xylenediamine, p-xylenediamine, hexamethylenediamime, 6,6′-diamine-2,2′-pyridyl, 4,4′-diaminobenzophenone, 4,4′-diaminoazobenzene, bis(4-aminophenyl)phenylmethane, 1,1-bis(4-aminophenyl)cyclohexane, 1,1-bis(4-amino-3-methylphenyl)cyclohexane, 2,5-bis(m-aminophenyl)-1,3,4-oxadiazole, 2,5-bis(p-aminophenyl)-1,3,4-oxadiazole, 2,5-bis(m-aminophenyl)thiazo(4,5-d)thiazole, 5,5′-di(m-aminophenyl)-(2,2)-bis-(1,3,4-oxadiazolyl), 4,4′-diaminodiphenylether, 4,4′-bis(p-aminophenyl)-2,2′-dithiazole, m-bis(4-p-aminophenyl-2-thiazolyl)benzene, 4,4′-diaminobenzanilide, 4,4′-diaminophenyl benzoate, N,N′-bis(4-aminobenzyl)-p-phenylenediamine, and 4,4′-methylenebis(2-chloroaniline); melamine, 2-amino-s-triazine, 2-amino-4-phenyl-s-triazine, 2-amino-4,6-diethyl-s-triazine, 2-amino-4,6-diphenyl-s-triazine, 2-amino-4,6-bis(p-methoxyphenyl)-s-triazine, 2-amino-4-anilino-s-triazine, 2-amino-4-phenoxy-s-triazine, 2-amino-4-chloro-s-triazine, 2-amino-4-aminomethyl-6-chloro-s-triazine, 2-(p-aminophenyl)-4,6-dichloro-s-triazine, 2,4-diamino-s-triazine, 2,4-diamino-6-methyl-s-triazine, 2,4-diamino-6-phenyl-s-triazine, 2,4-diamino-6-benzyl-s-triazine, 2,4-diamino-6-(p-aminophenyl)-s-triazine, 2,4-diamino-6-(m-aminophenyl)-s-triazine, 4-amino-6-phenyl-s-triazine-2-ol, and 6-amino-s-triazine-2,4-diol, and the like; and mixtures thereof. As for catalysts, suitable examples include, but are not limited to, dicumyl peroxide (DCP), α,α′-bis(t-butylperoxy)diisopropyl benzene, benzoyl peroxide (BPO), and combinations thereof.

Persons with ordinary skill in the art may select suitable curing agents and/or catalysts and determine the amount of the selected curing agents and/or catalysts based on their ordinary skill and disclosure of the subject application. Since these selections and determinations are not critical to the present invention, they will not be discussed in detail herein.

The resin composition of the present invention may optionally further comprise other additives, such as curing promoters, flame retardants, fillers, dispersing agents, flexibilizers, etc., in addition to the resin system (a) and metal hypophosphite (b). The curing promoters may promote the curing of the resin composition. The flame retardants may enhance the flame retardance of the material prepared thereby. The fillers may improve particular physicochemical properties of the material prepared thereby.

Examples of flame retardants include, but are not limited to, phosphorus-containing flame retardants, bromine-containing flame retardants, and combinations thereof. Examples of phosphorus-containing flame retardants include phosphatides, phosphazenes, ammonium polyphosphates, melamine polyphosphates, melamine cyanurates, and combinations thereof. Examples of bromine-containing flame retardants include tetrabromobisphenol A, decabromodiphenyloxide, decabrominated diphenyl ethane, 1,2-bis(tribromophenyl) ethane, brominated epoxy oligomer, octabromotrimethylphenyl indane, bis(2,3-dibromopropyl ether), tris(tribromophenyl)triazine, brominated aliphatic or aromatic hydrocarbon, and combinations thereof.

Examples of fillers include, but are not limited to, silica, aluminum oxide, magnesium oxide, magnesium hydroxide, calcium carbonate, talc, clays, aluminum nitride, boron nitride, aluminum hydroxide, silicon aluminum carbide, silicon carbide, sodium carbonate, titanium dioxide, zinc oxide, zirconium oxide, quartzs, diamonds, diamond-like carbon, graphites, calcined kaolin, pry an, micas, hydrotalcite, hollow silica, polytetrafluroroethylene (PTFE) powders, glass beads, ceramic whiskers, carbon nanotubes, nanosized inorganic powders, and combinations thereof.

There is no limit to the amount of each of the above additives and the amount can be determined depending on the needs by persons with ordinary skill in the art in accordance with their ordinary skill and disclosure of the present specification.

Regarding the preparation of the resin composition of the present invention, the resin composition may be prepared into varnish form for subsequent applications by evenly mixing the resin system (a), metal hypophosphite (b) and other optional additives through a stirrer and dissolving or dispersing the obtained mixture into a solvent. The solvent here can be any inert solvent which can dissolve (or disperse) but not react with the components of the resin composition of the present invention. For example, solvents which can dissolve or disperse the components of the resin composition of the present invention include, but are not limited to, toluene, γ-butyrolactone, methyl ethyl ketone, cyclohexanone, butanone, acetone, xylene, methyl isobutyl ketone, N,N-dimethylformamide (DMF), N,N-dimethylacetamide (DMAc), N-methyl-pyrolidone (NMP), or mixtures thereof. The amount of the solvent is not particularly limited as long as the components of the resin composition can be evenly mixed. In some embodiments of the present invention, a mixture of toluene, methyl ethyl ketone and γ-butyrolactone is used as the solvent.

The present invention further provides a prepreg which is obtained by immersing a substrate (a reinforcing material) into the abovementioned resin composition and drying the immersed substrate. Conventional reinforcing materials include glass fiber cloths (glass fabrics, glass papers, glass mats, etc.), kraft papers, short fiber cotton papers, nature fiber cloths, organic fiber cloths, etc. In some embodiments of the present invention, 2116 glass fiber cloths are illustrated as the reinforcing materials, and the reinforcing materials are heated and dried at 175° C. for 2 to 15 minutes (B-stage) to provide half-hardened prepregs.

The present invention further provides a laminate, which comprises a synthetic layer and a metal layer, wherein the synthetic layer is made from the above prepregs. The laminate may be prepared by the following process: superimposing a plurality of prepregs and superimposing a metal foil (such as a copper foil) on at least one external surface of the superimposed prepregs to provide a superimposed object; performing a hot-pressing operation onto the superimposed object to obtain the laminate. Moreover, a printed circuit board can be obtained by further patterning the metal foil of the laminate.

The present invention will be further illustrated by the embodiments hereinafter, wherein the measuring instruments and methods are respectively as follows:

[Water Absorption Test]

The moisture resistance of the laminate is tested by a pressure cooker test (PCT), i.e., subjecting the laminate into a pressure container (121° C., 100% R.H. and 1.2 atm) for 2 hours.

[Solder Resistance Test]

The solder resistance test is carried out by immersing the dried laminate in a solder bath at 288° C. for a while and observing whether there is any defect such as delamination and expansion.

[Peeling Strength Test]

Peeling strength refers to the bonding strength between the metal foil and laminated prepreg, which is usually expressed by the force required for vertically peeling the clad copper foil with a width of ⅛ inch from the surface of the laminated prepreg.

[Glass Transition Temperature (Tg) Test]

Glass transition temperature (Tg) is measured by using a Differential Scanning calorimeter (DSC), wherein the measuring methods are the IPC-TM-650.2.4.25C and 24C testing method of the Institute for Interconnecting and Packaging Electronic Circuits (IPC).

[Flame Retardance Test]

The flame retardance test is carried out according to UL94V (Vertical Burn), which comprises the burning of a laminate, which is held vertically, using a Bunsen burner to compare its self-extinguishing properties and combustion-supporting properties.

[Dielectric Constant and Dissipation Factor Measurement]

Dk and Df are measured according to ASTM D150 under an operating frequency of 10 GHz.

### EXAMPLE

<Preparation of Resin System (a)>

<Resin System (a1)>

According to the ratio shown in Table 1, polyphenylene ether resin of formula (II) (X has the structure of formula (II-1), Y has the structure of formula (II-2), wherein B1 and B2 are

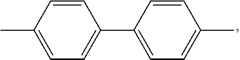

R5 and R6 are absent, and 1≦p+q<3, R1, R2, R3, and R4 are methyl, A1 and A2 are

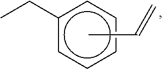

Z is absent, and 20≦(m+n)≦25; trade name: PP807, available from Jin-Yi Company), TAIC (available from Evonik Company), and benzoyl peroxide (BPO, available from Fluka Company) as the catalyst were mixed under room temperature with a stirrer followed by adding toluene, methyl ethyl ketone and γ-butyrolactone (all available from Fluka Company) thereinto. After stirring the resultant mixture under room temperature for about 60 to 120 minutes, resin system (a1) was obtained.

<Resin System (a2)>

The preparation procedures of resin system (a1) were repeated to prepare resin system (a2), except that polyphenylene ether resin available from Sabic Company (trade name: SA9000) and bismaleimide resin of formula (III) (M1 is

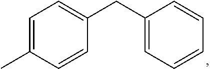

and the Z1 groups are H; trade name: BMI, available from K.I CHEMICAL Company) were further added, and the amount of polyphenylene ether resin PP807 was adjusted as shown in Table 1.

<Resin System (a3)>

The preparation procedures of resin system (a1) were repeated to prepare resin system (a3), except that polyphenylene ether resin PP807 was substituted by polyphenylene ether resin available from Mitsubishi Gas Chemical Company (trade name: OPE-2st), and homopolymers of butadiene (trade name: Ricon 130 and Ricon 150; all available from CRAY VALLEY Company) as the elastomers were further added as shown in Table 1.

<Resin System (a4)>

The preparation procedures of resin system (a1) were repeated to prepare resin system (a4), except that polyphenylene ether resin PP807 was substituted by polyphenylene ether resin SA9000, and butadiene-styrene random copolymer (trade name: Ricon 181, available from CRAY VALLEY Company) and styrene-butadiene-styrene copolymer (trade name: D1118K, available from KRATON Company) as the elastomers, bisphenol A type epoxy resin (trade name: BE-188EL, available from CCP Company), and methylenebis(2-ethyl-6-methylaniline) (MED, available from IHARA CHMICAL Ind.) as the curing agent were further added as shown in Table 1.

<Resin System (a5)>

The preparation procedures of resin system (a2) were repeated to prepare resin system (a5), except that polyphenylene ether resin SA900 was substituted by polyphenylene ether resin OPE-2st, homopolymer of butadiene Ricon 130 as the elastomer, dicyclopentadiene type epoxy resin (trade name: HP-7200H, available from DIC Company), and phenol (available from ChangChun Chemical Company) as the curing agent were further added as shown in Table 1. In addition, the catalyst was not added as shown in Table 1.

<Resin System (a6)>

The preparation procedures of resin system (a2) were repeated to prepare resin system (a6), except that polyphenylene ether resin PP807 was substituted by polyphenylene ether resin OPE-2st, homopolymer of butadiene Ricon 150, butadiene-styrene random copolymer Ricon 181, and styrene-butadiene-styrene copolymer D1118K as the elastomers were further added, and the amount of the bismaleimide resin BMI was adjusted as shown in Table 1.

<Resin System (a7)>

According to the ratio shown in Table 1, bismaleimide resin BMI, isocyanurate TAIC, elastomers (homopolymer of butadiene Ricon 130, butadiene-styrene random copolymer Ricon 181, and styrene-butadiene-styrene copolymer D1118K), epoxy resin HP-7200H, and phenol as the curing agent were mixed under room temperature with a stirrer followed by adding toluene, methyl ethyl ketone and γ-butyrolactone thereinto. After stirring the resultant mixture under room temperature for about 60 to 120 minutes, resin system (a7) was obtained.

<Resin System (a8)>

The preparation procedures of resin system (a5) were repeated to prepare resin system (a8), except that TAIC, epoxy resin and curing agent were not added, homopolymer of butadiene Ricon 130 was substituted by butadiene-styrene random copolymer Ricon 181 and styrene-butadiene-styrene copolymer D1118K, and the amount of bismaleimide resin BMI was adjusted as shown in Table 1.

In order to measure the Df values of the resin systems, electrometric samples were prepared by using resin systems (a1) to (a8), respectively. Resin systems (a1) to (a8) were coated on copper foils by a horizontal knife of a horizontal coater, respectively, and the coated copper foils were then placed in an oven and dried at 175° C. for 2 to 10 minutes to prepare resin coated copper foils in a half-cured state. Next, a hot-pressing operation was performed on each of resin coated copper foils (in a half-cured state) with a further sheet of copper foil (0.5 oz.), herein, the hot-pressing conditions are as follows: raising the temperature to about 200° C. to 220° C. with a heating rate of 3.0° C./min, and hot-pressing for 180 minutes under the full pressure of 15 kg/cm² (initial pressure is 8 kg/cm²) at said temperature. Then, the Df values of resin systems (a1) to (a8) were measured at 10 GHz. As shown in Table 1, the Df values of resin systems (a1) to (a8) at 10 GHz are all lower than 0.006.

TABLE 1
Composition of resin systems

| | | resin system | | | | | | | |
|---|---|---|---|---|---|---|---|---|---|
| parts by weight | | (a1) | (a2) | (a3) | (a4) | (a5) | (a6) | (a7) | (a8) |
| polyphenylene | PP807 | 60 | 30 | — | — | 30 | — | — | 30 |
| ether resin | SA9000 | — | 30 | — | 60 | — | 30 | — | — |
| | OPE-2st | — | — | 60 | — | 30 | 30 | — | 30 |
| bismaleimide | BMI | — | 10 | — | — | 10 | 5 | 8 | 5 |
| resin | | | | | | | | | |
| isocyanurate | TAIC | 20 | 20 | 20 | 20 | 20 | 20 | 5 | 0 |
| elastomer | Ricon 130 | — | — | 10 | — | 5 | — | 5 | — |
| | Ricon 150 | — | — | 10 | — | — | 10 | — | — |
| | Ricon 181 | — | — | — | 10 | — | 5 | 10 | 10 |
| | D1118 K | — | — | — | 5 | — | 5 | 5 | 5 |
| epoxy resin | HP-7200H | — | — | — | — | 10 | — | 20 | — |
| | BE-188EL | — | — | — | 10 | — | — | — | — |
| other curing | Phenol | — | — | — | — | 6 | — | 8 | — |
| agent | MED | — | — | — | 5 | — | — | — | — |
| other catalyst | BPO | 0.3 | 0.3 | 0.3 | 0.3 | — | 0.3 | — | — |

| | | | | | | | | |
|---|---|---|---|---|---|---|---|---|
| Df@10 GHz | 0.0033 | 0.0038 | 0.0025 | 0.0045 | 0.0042 | 0.0027 | 0.0060 | 0.0030 |

<Preparation of Resin Composition>

### Example 1

According to the ratio shown in Table 2, resin system (a1), metal hypophosphite of formula (I) (a is 3, and M^{a+} is Al³⁺), and silica powders (available from Sibelco Company) as the filler were mixed under room temperature with a stirrer for about 120 minutes to obtain resin composition 1.

### Example 2

The preparation procedures of Example 1 were repeated to prepare resin composition 2, except that flame retardant SPB100 (available from Otuska Chemical Company) was further added, and the amount of metal hypophosphite was adjusted as shown in Table 2.

### Example 3

The preparation procedures of Example 1 were repeated to prepare resin composition 3, except that resin system (a2) was used as the resin system (a) as shown in Table 2.

### Example 4

The preparation procedures of Example 3 were repeated to prepare resin composition 4, except that SPB100 was further added, and the amount of metal hypophosphite was adjusted as shown in Table 2.

### Example 5

The preparation procedures of Example 1 were repeated to prepare resin composition 5, except that resin system (a3) was used as the resin system (a), and the amounts of metal hypophosphite and the filler were adjusted as shown in Table 2.

### Example 6

The preparation procedures of Example 5 were repeated to prepare resin composition 6, except that resin system (a4) was used as the resin system (a), and SPB100 was further added as shown in Table 2.

### Example 7

The preparation procedures of Example 6 were repeated to prepare resin composition 7, except that resin system (a5) was used as the resin system (a), and the amounts of metal hypophosphite and SPB100 were adjusted as shown in Table 2.

### Example 8

The preparation procedures of Example 5 were repeated to prepare resin composition 8, except that the amount of metal hypophosphite was adjusted as shown in Table 2.

### Example 9

The preparation procedures of Example 6 were repeated to prepare resin composition 9, except that resin system (a6) was used as the resin system (a), and the amounts of metal hypophosphite and SPB100 were adjusted as shown in Table 2.

### Example 10

The preparation procedures of Example 1 were repeated to prepare resin composition 10, except that resin system (a7) was used as the resin system (a), and the amount of metal hypophosphite was adjusted as shown in Table 2.

### Example 11

The preparation procedures of Example 10 were repeated to prepare resin composition 11, except that resin system (a8) was used as the resin system (a) as shown in Table 2.

### Comparative Example 1

The preparation procedures of Example 5 were repeated to prepare comparative resin composition 1, except that the amounts of metal hypophosphite and the filler were adjusted as shown in Table 2.

### Comparative Example 2

The preparation procedures of Example 6 were repeated to prepare comparative resin composition 2, except that metal hypophosphite was not added, and the amount of SPB100 was adjusted as shown in Table 2.

TABLE 2
Composition of resin compositions

| | | | | flame | |
|---|---|---|---|---|---|
| | | | metal | retardant | silica |
| | | resin | hypophosphite | (SPB100) | powder |
| | | system | (b) (parts | (parts | (parts by |
| | | (a) | by weight) | by weight) | weight) |
| Example | 1 | (a1) | 15 | — | 25 |
| | 2 | (a1) | 5 | 10 | 25 |
| | 3 | (a2) | 15 | — | 25 |
| | 4 | (a2) | 12 | 3 | 25 |
| | 5 | (a3) | 18 | — | 30 |
| | 6 | (a4) | 18 | 2 | 30 |
| | 7 | (a5) | 17 | 4 | 30 |
| | 8 | (a3) | 35 | — | 30 |
| | 9 | (a6) | 16 | 5 | 30 |
| | 10 | (a7) | 16 | — | 25 |
| | 11 | (a8) | 16 | — | 25 |
| Comparative | 1 | (a3) | 45 | — | 20 |
| Example | 2 | (a4) | — | 27 | 30 |

[Preparation of Laminate]

Laminates 1 to 11 and comparative laminates 1 and 2 were prepared by using the resin compositions 1 to 11 and comparative resin compositions 1 and 2, respectively. In detail, one of the resin compositions was coated on 2116 reinforced glass fiber cloths by a roller. The coated 2116 reinforced glass fiber cloths were then placed in an oven and dried at 175° C. for 2 to 15 minutes to produce prepregs in a half-cured state (resin content: about 53%). Four pieces of the prepregs were superimposed and two sheets of copper foil (0.5 oz.) were respectively superimposed on the two external surfaces of the superimposed prepregs to provide a superimposed object. A hot-pressing operation was performed on each of the prepared objects to provide laminates 1 to 11 (corresponding to the resin compositions 1 to 11, respectively) and comparative laminates 1 and 2 (corresponding to the comparative resin compositions 1 and 2, respectively). Herein, the hot-pressing conditions are as follows: raising the temperature to about 200° C. to 220° C. with a heating rate of 3.0° C./min, and hot-pressing for 180 minutes under the full pressure of 15 kg/cm² (initial pressure is 8 kg/cm²) at said temperature.

The water absorption, solder resistance, peeling strength, glass transition temperature (Tg), flame retardance, dielectric constant (Dk), dissipation factor (DO of the laminates 1 to 11 and comparative laminates 1 and 2 were analyzed and the results are tabulated in Table 3.

TABLE 3
Properties of laminates

| | | water | solder | peeling | | flame | | |
|---|---|---|---|---|---|---|---|---|
| | | absorption | resistance | strength | Tg | retardance | Df | Dk |
| unit | | % | minute | pound/inch | ° C. | UL grade | 10 GHz | 10 GHz |
| laminate | 1 | 0.42 | >10 | 3.81 | 196 | V0 | 0.0061 | 3.89 |
| | 2 | 0.43 | >10 | 3.80 | 190 | V0 | 0.0063 | 3.97 |
| | 3 | 0.42 | >10 | 3.85 | 206 | V0 | 0.0066 | 3.90 |
| | 4 | 0.43 | >10 | 3.82 | 205 | V0 | 0.0068 | 3.90 |
| | 5 | 0.42 | >10 | 3.83 | 195 | V0 | 0.0054 | 3.83 |
| | 6 | 0.48 | >10 | 4.01 | 193 | V0 | 0.0074 | 3.96 |
| | 7 | 0.47 | >10 | 3.95 | 202 | V0 | 0.0071 | 3.95 |
| | 8 | 0.42 | >10 | 3.35 | 200 | V0 | 0.0058 | 3.86 |
| | 9 | 0.44 | >10 | 3.83 | 202 | V0 | 0.0057 | 3.86 |
| | 10 | 0.56 | >10 | 4.10 | 186 | V0 | 0.0078 | 3.99 |
| | 11 | 0.43 | >10 | 3.86 | 203 | V0 | 0.0056 | 3.85 |
| comparative | 1 | 0.43 | >10 | 2.52 | 185 | V0 | 0.0060 | 3.86 |
| laminate | 2 | 0.55 | >10 | 3.10 | 173 | V0 | 0.0078 | 3.98 |

As shown in Table 3, the laminates 1 to 11 manufactured by using the resin compositions of the present invention are provided with satisfactory physicochemical properties and electrical properties (such as water absorption, flame retardance, Dk, and DO, and outstanding heat resistance (high Tg and excellent solder resistance). Thus, the resin composition of the present invention can be more extensively used. In particular, the laminates prepared by using the resin composition of the present invention are provided with excellent peeling strength (reach 3.35 pounds/inch or more), and in the case where the amount of metal hypophosphite (b) is in a preferred range, i.e., 10 wt % to 22 wt % (Examples 1, 3 to 7, and 9 to 11), the peeling strength of the resultant laminates is particularly excellent (reach 3.81 pounds/inch or more). Furthermore, as shown in Comparative Example 1, it is surprising that if the amount of metal hypophosphite (b) exceeds the range designated by the present invention, even though the amount of metal hypophosphite (b) is increased, the peeling strength of the resultant laminates will decrease sharply (only 2.52 pounds/inch). In addition, as shown in Comparative Example 2, when metal hypophosphite (b) is not added into the resin composition, the physicochemical properties of the resultant laminates apparently become poor. Even though the flame retardance of the resultant laminates may reach V-0 grade in the presence of other flame retardant, the glass transition temperature and peeling strength of the resultant laminates remain poor.

The above examples are used to illustrate the principle and efficacy of the present invention and show the inventive features thereof. People skilled in this field may proceed with a variety of modifications and replacements based on the disclosures and suggestions of the invention as described without departing from the principle and spirit thereof. Therefore, the scope of protection of the present invention is that as defined in the claims as appended.

What is claimed is:

1. A resin composition, comprising:
(a) a thermal-curable resin system, which has a dielectric loss (DO of not higher than 0.006 at 10 GHz; and
(b) a metal hypophosphite of formula (I), 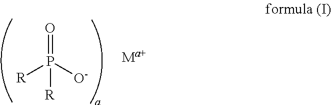
wherein, a is an integer from 1 to 4, R is H or absent, and M^{a+} is an ion of a metal selected from the group consisting of lithium, sodium, potassium, magnesium, calcium, strontium, barium, aluminum, germanium, tin, antimony, zinc, titanium, zirconium, manganese, iron, copper, and cerium,
wherein the amount of the metal hypophosphite (b) is 1 wt % to 30 wt % based on the total weight of the resin system (a) and the metal hypophosphite (b).

2. The resin composition of claim 1, wherein the amount of the metal hypophosphite (b) is 10 wt % to 22 wt % based on the total weight of the resin system (a) and the metal hypophosphite (b).

3. The resin composition of claim 1, wherein a is an integer from 1 to 3, and M^{a+} is an ion of a metal selected from the group consisting of lithium, sodium, potassium, magnesium, calcium, strontium, barium, and aluminum.

4. The resin composition of claim 3, wherein a is 3, and M^{a+} is Al³⁺.

5. The resin composition of claim 1, wherein the resin system (a) comprises thermal-curable resin(s) selected from the group consisting of polyphenylene ether resins, bismaleimide resins, isocyanurates containing vinyl and/or allyl, elastomers containing butadiene and/or styrene, and epoxy resins.

6. The resin composition of claim 2, wherein the resin system (a) comprises thermal-curable resin(s) selected from the group consisting of polyphenylene ether resins, bismaleimide resins, isocyanurates containing vinyl and/or allyl, elastomers containing butadiene and/or styrene, and epoxy resins.

7. The resin composition of claim 3, wherein the resin system (a) comprises thermal-curable resin(s) selected from the group consisting of polyphenylene ether resins, bismaleimide resins, isocyanurates containing vinyl and/or allyl, elastomers containing butadiene and/or styrene, and epoxy resins.

8. The resin composition of claim 4, wherein the resin system (a) comprises thermal-curable resin(s) selected from the group consisting of polyphenylene ether resins, bismaleimide resins, isocyanurates containing vinyl and/or allyl, elastomers containing butadiene and/or styrene, and epoxy resins.

9. The resin composition of claim 5, wherein the polyphenylene ether resins have the structure of formula (II): 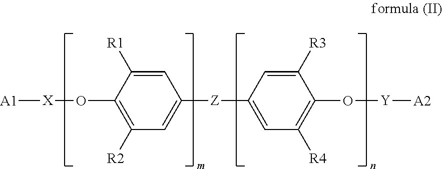
wherein X and Y are independently 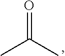
an alkenyl-containing group or absent;
R1, R2, R3 and R4 are independently H or substituted or unsubstituted C₁-C₅ alkyl;
m and n are independently an integer from 0 to 100, with the proviso that m and n are not 0 at the same time;
A1 and A2 are independently 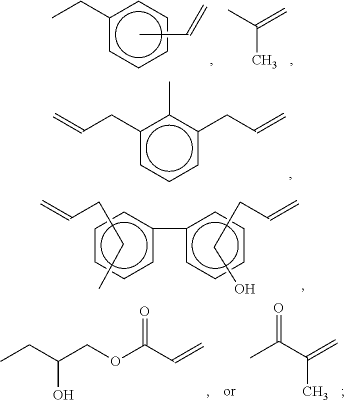
and
Z is absent, —O—, 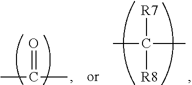
wherein R7 and R8 are independently H or C₁-C₁₂ alkyl.

10. The resin composition of claim 5, wherein the bismaleimide resins have the structure of formula 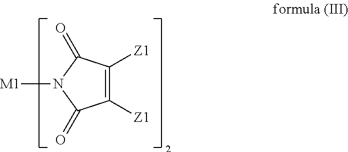
wherein M1 is a C₂-C₄₀ divalent group and is aliphatic, alicyclic, aromatic, or heterocyclic, and the Z1 groups are independently H, halogen, or C₁-C₅ alkyl.

11. The resin composition of claim 5, wherein the isocyanurates containing vinyl and/or allyl are selected from the group consisting of triallyl isocyanurate (TAIC), triallyl cyanurate (TAC), and a combination thereof.

12. The resin composition of claim 5, wherein the elastomers are selected from the group consisting of homopolymers of butadiene, styrene-butadiene copolymers (SBR), styrene-butadiene-styrene copolymers (SBS), acrylonitrile-butadiene copolymers, hydrogenated styrene-butadiene-styrene copolymers, styrene-isoprene-styrene copolymers (SIS), hydrogenated styrene-isoprene-styrene copolymers, hydrogenated styrene (butadiene/isoprene) styrene copolymers, polystyrene, and combinations thereof.

13. The resin composition of claim 5, wherein the epoxy resins have the structure of formula (IV): 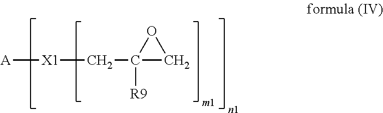
wherein A is an organic or inorganic group of valence n1, R9 is H or C₁-C₆ alkyl, X1 is oxygen or nitrogen, m1 is 1 or 2 and consistent with the valence of X1, and n1 is an integer from 1 to 100.

14. The resin composition of claim 1, wherein the resin system (a) further comprises a catalyst selected from the group consisting of dicumyl peroxide (DCP), α,α′-bis(t-butylperoxy)diisopropyl benzene, benzoyl peroxide (BPO), and combinations thereof.

15. The resin composition of claim 1, further comprising one or more additives selected from the group consisting of curing promoters, flame retardants, fillers, dispersing agents, flexibilizers, and combinations thereof.

16. The resin composition of claim 15, wherein the flame retardants are selected from the group consisting of phosphorus-containing flame retardants, bromine-containing flame retardants, and combinations thereof.

17. The resin composition of claim 15, wherein the fillers are selected from the group consisting of silica, aluminum oxide, magnesium oxide, magnesium hydroxide, calcium carbonate, talc, clays, aluminum nitride, boron nitride, aluminum hydroxide, silicon aluminum carbide, silicon carbide, sodium carbonate, titanium dioxide, zinc oxide, zirconium oxide, quartzs, diamonds, diamond-like carbon, graphites, calcined kaolin, pryan, micas, hydrotalcite, hollow silica, polytetrafluroroethylene (PTFE) powders, glass beads, ceramic whiskers, carbon nanotubes, nanosized inorganic powders, and combinations thereof.

18. A prepreg, which is prepared by immersing a substrate into the resin composition of claim 1, and drying the immersed substrate.

19. A laminate, comprising a synthetic layer and a metal layer, wherein the synthetic layer is made from the prepreg of claim 18.
